(19) United States
(12) Patent Application Publication
(10) Pub. No.: US 2024/0388520 A1
(43) Pub. Date: Nov. 21, 2024

(54) EDGE COMPUTING WITH ARTIFICIAL INTELLIGENCE AND ADVANCED ANALYTICS

(71) Applicant: Wells Fargo Bank, N.A., San Francisco, CA (US)

(72) Inventor: Azita Asefi, Vacaville, CA (US)

(21) Appl. No.: 18/664,513

(22) Filed: May 15, 2024

Related U.S. Application Data
(60) Provisional application No. 63/502,308, filed on May 15, 2023.

(51) Int. Cl. H04L 43/50; H04L 41/16

(52) U.S. Cl. CPC H04L 43/50; H04L 41/16

(57) ABSTRACT

An example computer system for using edge computing to enhance artificial intelligence and advanced analytics can include: one or more processors; and non-transitory computer-readable storage media encoding instructions which, when executed by the one or more processors, causes the computer system to: provide a data layer including a data source; use an edge computing layer to pre-process data from the data source; perform the artificial intelligence and advanced analytics on the data to form insights into the data; provide the insights to a data center or a cloud computing environment located remotely from the data source; and perform further artificial intelligence and advanced analytics on the insights at the data center or the cloud computing environment.

### BACKGROUND

Edge computing refers to the decentralized approach of processing and analyzing data closer to the source, at the edge of a network, rather than relying solely on a central cloud or data center. By bringing computation and data storage closer to where it is generated, edge computing minimizes latency, optimizes bandwidth usage, and enhances real-time analytics, security, and privacy. It enables faster decision-making, improves the reliability of applications, and supports the efficient handling of massive amounts of data generated by various computing devices.

### SUMMARY

The present disclosure relates to edge computing with artificial intelligence and advanced analytics.

In one example, a computer system for using edge computing to enhance artificial intelligence and advanced analytics can include: one or more processors; and non-transitory computer-readable storage media encoding instructions which, when executed by the one or more processors, causes the computer system to: provide a data layer including a data source; use an edge computing layer to pre-process data from the data source; perform the artificial intelligence and advanced analytics on the data to form insights into the data; provide the insights to a data center or a cloud computing environment located remotely from the data source; and perform further artificial intelligence and advanced analytics on the insights at the data center or the cloud computing environment.

### DESCRIPTION OF THE DRAWINGS

FIG. 1 shows an example system for providing edge computing with artificial intelligence and advanced analytics.

FIG. 2 shows additional components of the system of FIG. 1.

FIG. 3 shows another example system for providing edge computing with artificial intelligence and advanced analytics.

FIG. 4 shows an example implementation of the system of FIG. 3.

FIG. 5 shows example components of a computing device used to implement functionality described herein.

### DETAILED DESCRIPTION

This disclosure relates to the use of edge computing to enhance artificial intelligence and advanced analytics.

Generally, edge computing can be leveraged as a distributed computing model that supports processing power and analysis closer to a data source, rather than in a centralized data center that is located remotely from the data source. Edge computing can be used to reduce latency, increase privacy, reduce cost, and/or improve scalability.

The examples provided herein can include an edge computing layer that is positioned between a data layer and an artificial intelligence and advanced analytics computing layer to leverage the advantages of edge computing.

For instance, in some examples provided herein, edge computing is provided between the data source and the traditional data center. This allows artificial intelligence and advanced analytics to be provided closer to the data source. Further, more comprehensive artificial intelligence and advanced analytics can be provided at the traditional data center. Many configurations are possible, as described further below.

There can be many advantageous associated with the use of artificial intelligence (including machine learning) and advanced analytics. These include:
Improved decision-making: artificial intelligence and advanced analytics can help businesses make better and more informed decisions by analyzing large amounts of data and identifying patterns and trends that may not be immediately apparent to humans;
Increased efficiency: by automating certain tasks and processes, artificial intelligence and advanced analytics can help businesses increase their operational efficiency and reduce costs;
Enhanced customer and employee experience: artificial intelligence and advanced analytics can help businesses personalize interactions with customers and employees and provide them with more relevant and targeted recommendations, which can improve the overall customer and employee experience;
Competitive advantage: by leveraging artificial intelligence and advanced analytics, businesses can gain a competitive advantage by identifying new opportunities, developing new products or services, and improving existing ones;
Improved risk management: artificial intelligence and advanced analytics can help businesses identify potential risks and mitigate them before they become a problem, which can help reduce financial and reputational damage; and
Regulatory compliance: artificial intelligence and advanced analytics can help businesses comply with regulations by providing real-time monitoring and analysis of data, identifying potential compliance issues, and alerting stakeholders to potential violations.

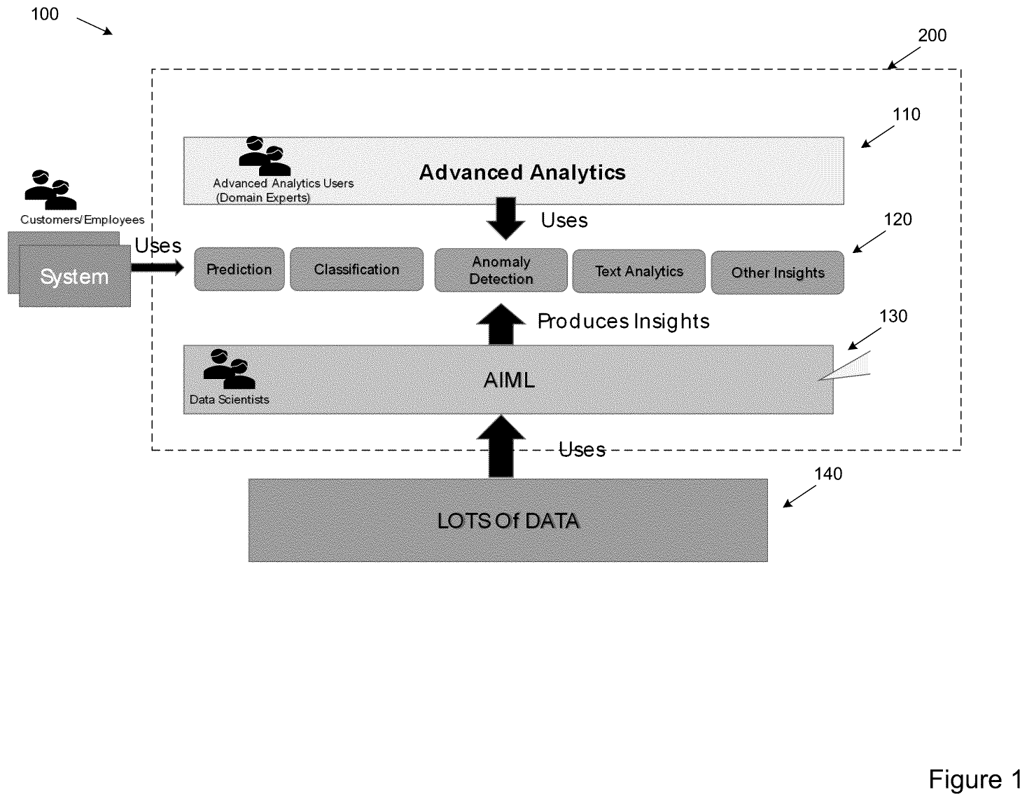

Referring now to FIG. 1, an example system 100 is shown. This system 100 includes artificial intelligence 130 and advanced analytics 110 that act upon a data source. The system 100 can perform various tasks 120 based upon the data source, such as prediction, classification, anomaly detection, text analytics, etc.

Machine learning is a discipline of artificial intelligence 130 and is about training a machine or system, such as the system 100, using data 140 to learn information and insights, recognize patterns and provide answers to a problem using a significant amount of data. There are several types of machine learning:
Supervised learning: training a machine to provide correct answers based on known answers, which requires feature engineering;
Unsupervised learning: finding previously unknown structure in data;
Deep learning: training based on raw data without need for feature engineering;
Reinforcement learning: trial and error learning scheme, in which learning to perform and action are based on receiving evaluation and feedback.

Advanced analytics 110 techniques can be used to gain deeper insights into data. Advanced analytics 110 involve more complex and predictive modeling techniques to identify patterns and make predictions about future events. Examples of advanced analytics 110 include:
Predictive modeling: this involves using statistical algorithms and machine learning techniques to identify patterns in data and make predictions about future outcomes;
Text analytics: this involves using natural language processing (NLP) techniques to analyze unstructured, semi-structured, structured data, such as text documents, emails, etc. to identify trends and patterns;
Data mining: this involves identifying patterns and relationships in large datasets using statistical and machine learning techniques; and
Machine learning: this involves using algorithms to learn patterns in data and make predictions or take actions based on that learning.

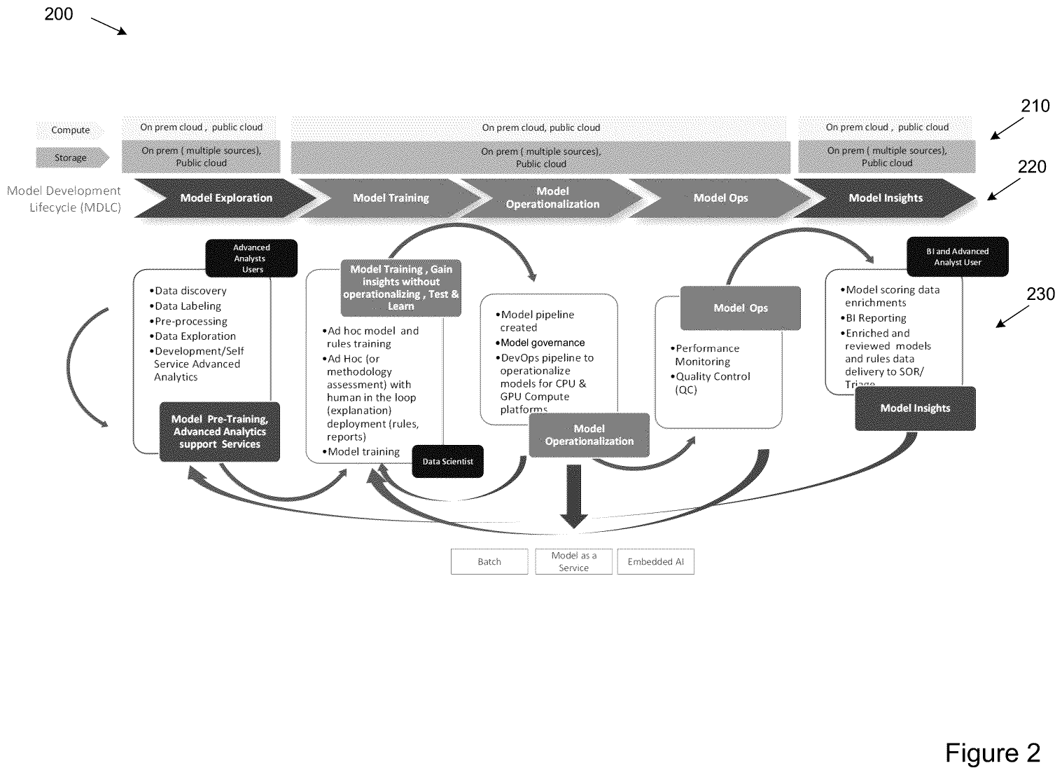

Referring now to FIG. 2, in example embodiments, components of the system 100 provide a unified artificial intelligence and advanced analytics platform 200. This unified artificial intelligence and advanced analytics platform 200 caters to various needs within businesses. The system 100, including the platform 200, can enable collaboration of data scientists and domain experts, as well as facilitate model governances.

The example unified platform 200 can provide advantages throughout the lifecycle of model development 220. This can include data exploration, model training, model operationalization, model operations, and model insights.

The system 100 can thereby provide the ability to manage end-to-end lifecycle management and governance. Further, it can provide visibility to data through intelligent data management and facilitate advanced workflow and workspace capabilities 230. In addition, in some embodiments, the system 100 can provide data and computing anywhere that is desired.

For example, the system 100 can leave data where it currently resides. This can improve business agility by accessing data from anywhere, which allows the system 100 to respond to business requirements more quickly. It can also enhance security by utilizing data across multiple locations, including computing and storage of data on premises and in the could 210, to keep critical data in source systems. Further, the system 100 can reduce the costs of managing and risk of data duplication as data can stay where it currently resides.

The system 100 can also improve performance by moving computing resources and workloads closer to where data is generated and processed. This can reduce costs by selecting more cost-effective computing options in different locations. Further, the system 100 can enable support for real-time use cases while minimizing complex or expensive implementations.

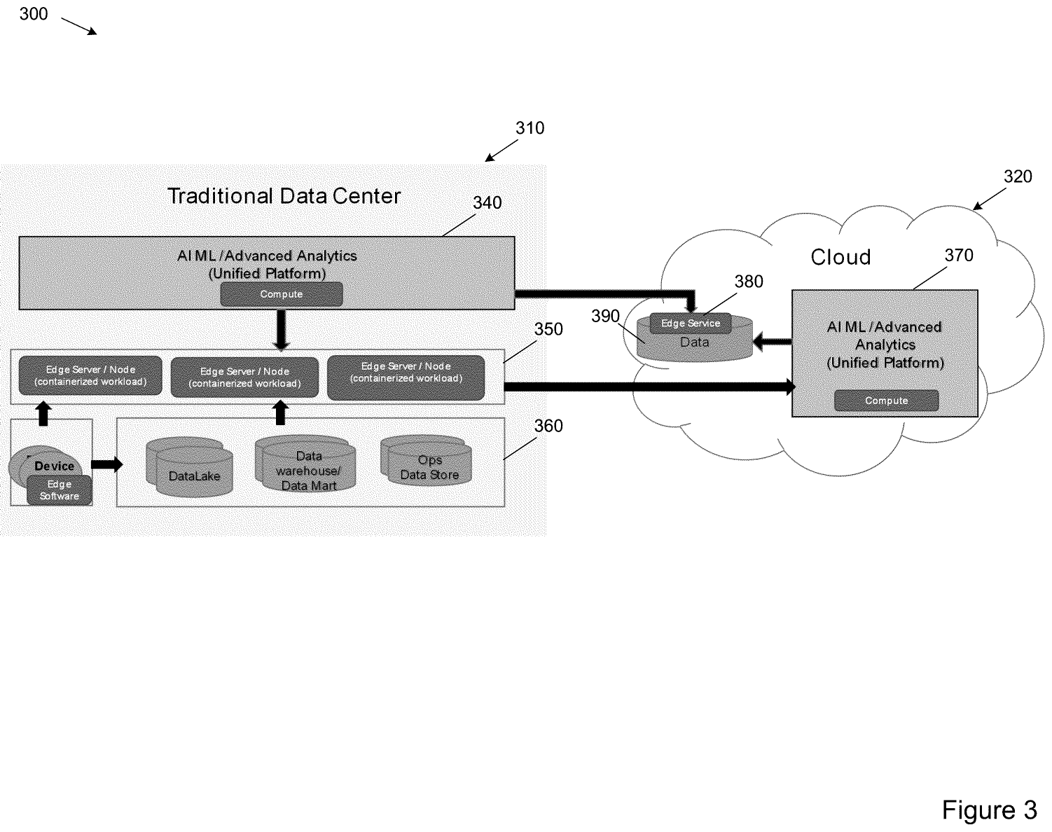

Referring now to FIG. 3, another example system 300 is shown. This system 300 is similar to the system 100 described above, in that the system 300 includes artificial intelligence and advanced analytics that act upon a data source. However, the system 300 provides both a traditional data center 310 and a cloud computing environment 320.

The system 300 is a unified platform allowing for data to be accessed anywhere. Data replication is thereby minimized. Further, the system 300 can provide for computing from anywhere, creating distributed processing closer to the data source using edge computing 350.

Edge computing is a distributed computing model that supports processing power and analysis closer to the data source, rather than in a centralized data center that is located remotely from the data source. The system 300 exhibits various advantages associated with edge computing, including one or more of the following:
Reduced latency: edge computing can significantly reduce the latency associated with sending data to a centralized location for processing, which can be important for applications that require real-time analysis, such as autonomous vehicles, industrial automation, and healthcare monitoring, fraud detection, etc.;
Increased privacy: edge computing can also help improve privacy by keeping data on the device or at the edge, rather than sending it to a centralized location where it may be more vulnerable to unauthorized access or breaches;
Reduced costs: edge computing can help reduce costs by reducing the amount of data that needs to be transmitted and stored in a centralized location, which can also help reduce the bandwidth requirements for transmitting data; and
Improved scalability and performance: edge computing can also help improve scalability by allowing for distributed processing of data across multiple edge devices.

In this example, the system 300 positions edge computing 350 between the data source 360 and the artificial intelligence and advanced analytics 340 provided in the traditional data center 310. In this example, the edge computing 350 can include aspects such as edge servers and nodes that provide containerized workloads.

In the examples provided herein, the edge computing 350 can take various forms. This can include data collection and initial data processing. For instance, devices and sensors, like Internet of Things (IoT) sensors, mobile phones, or local edge servers can generate such data. These may perform some basic processing and filtering of data to avoid sending unnecessary information back to the cloud or central servers. Examples of such sensors include temperature sensors, motion detectors, cameras, and other specialized sensors that collect environmental data. Such sensors are Typically low power, small in size, and designed to perform specific tasks efficiently. Mobiles devices, such as smartphones and tablets, can serve as edge devices by processing local data and performing tasks like image recognition or local data aggregation. These devices have more powerful processors, significant memory, and connectivity options (Wi-Fi, LTE).

The edge computing 350 can also include local data processing, such as edge nodes and edge servers. In these instances, data is processed directly on the edge devices or nearby edge nodes (computers or servers located close to the data source). These could include high-performance CPUs, increased RAM, and sometimes equipped with GPUs or FPGAs (Field-Programmable Gate Arrays), and ASICs (Application-Specific Integrated Circuits) for intensive computation tasks. This can significantly reduce latency as the data does not have to travel to a distant data center. Specific edge applications are deployed on these nodes, which are optimized for low-power operation and rapid processing. Edge computing software can analyze data in real time, allowing for immediate actions that are critical in many industrial, automotive, or security applications. Some edge software can run lightweight machine learning models to make intelligent decisions based on the incoming data without needing central server input. Technologies like Docker and Kubernetes at the edge help in deploying and managing applications efficiently across various devices. Further data streaming and management tools: can manage data flow, handle intermittent connectivity, and ensure data integrity.

The edge computing 350 can further include devices on the edge can communicate with each other to share information and make decentralized decisions. Essential data, or data needing further analysis, is sent to the cloud. Edge software can determine what data is urgent or important based on predefined rules or AI algorithms. Gateways can serve as the intermediary between edge devices and the broader network or cloud. They aggregate data from multiple sensors and perform preliminary processing includes

Finally, the edge computing 350 can provide remote management, including software updates, data synchronization, and system management that are handled remotely, often through a central management platform that ensures all edge devices are updated and secure. Coordination between various edge devices and the central system is important, especially when managing large numbers of devices. This involves deploying applications, managing data flows, and ensuring consistent operations across the network. Edge computing enhances security by allowing sensitive data to be processed locally rather than being transmitted to a central location where it might be more vulnerable to attacks.

In addition, the system 300 provides enhanced artificial intelligence and advanced analytics 370 in the cloud computing environment 320, along with an edge service 380 positioned between the data 390 and the traditional data center 310. Non-limiting examples of cloud computing environments include Azure Cloud from Microsoft, Google Cloud from Google, and AWS from Amazon.

In this manner, artificial intelligence and advanced analytics 370 can be provided with low latency at the source of the data 390 within the system 300. Further, more enhanced artificial intelligence and advanced analytics 340 can be provided at more traditional points within the system 300, such as at the traditional data center 310 and in the cloud computing environment 320. Examples of such artificial intelligence include classification, prediction, anomaly detection, and text analytics.

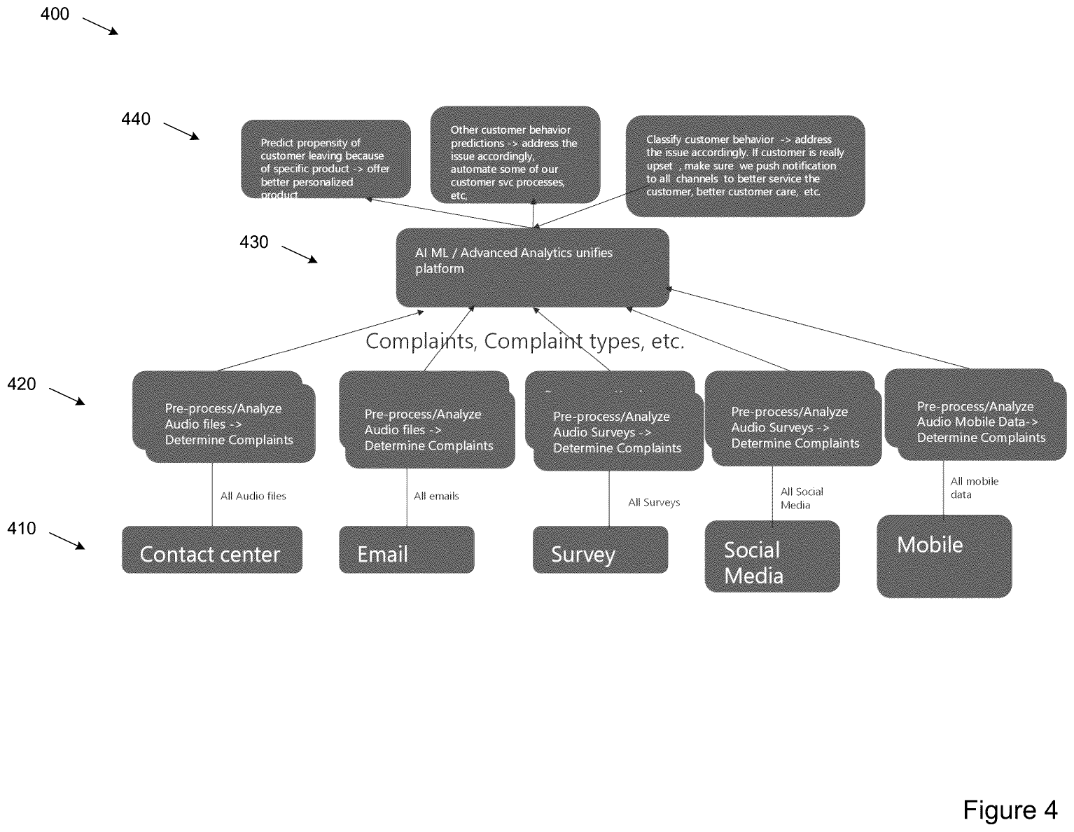

Referring now to FIG. 4, an example implementation 400 by the system 300 is provided. The implementation 400 is driven by edge computing and provides low latency artificial intelligence and advanced analytics at the data source.

In this example, the implementation 400 is provided at a financial institution that services the banking needs of customers. However, the implementation 400 can be equally applicable to any other service industry.

A data layer 410 in the implementation 400 is the source of customer data. This can include various interfaces with customers, including a contact center (e.g., audio files) that provides call-in services for customers. Data can also be gathered from other sources, such as email, surveys, social media, and/or mobile data.

An edge layer 420 in the implementation 400 is located at or near the data layer to provide low latency processing of the customer data. This can include pre-processing of the customer data to determine complaints. For instance, the audio files from the contact center can be pre-processed to determine when customers have complaints.

A core platform 430 in the implementation 400 is provided to apply artificial intelligence and advanced analytics at the data source. The artificial intelligence and advanced analytics can drive an insights layer 440 in the implementation 400. The insights layer 440 provides various example conclusions based upon the analysis of the customer data, including:
Predict propensity of customer leaving because of specific product to thereby offer a better personalized product;
Other customer behavior predictions to anticipate issues accordingly, automate customer service processes, etc.; and
Classify customer behavior to thereby address issues accordingly; for instance, if the customer is really upset, notifications can be issued on appropriate channels to better service the customer, etc.

The configuration of the system 300 and implementation 400 including edge computing can be equally applicable to other implementations. Examples of such implementations include:
Autonomous Vehicles: edge computing can be used to process data from sensors on autonomous vehicles in real-time, allowing for rapid decision-making and improved safety;
Smart Factories: edge computing can be used to monitor and analyze data from machines and equipment in a factory setting, enabling predictive maintenance and improved production efficiency;
Healthcare: edge computing can be used to process and analyze medical data in real-time, allowing for faster diagnoses and better patient outcomes;
Retail: edge computing can be used to analyze customer data in real-time, enabling retailers to provide personalized recommendations and improve the customer experience;
Energy: edge computing can be used to monitor and analyze data from renewable energy sources, enabling more efficient and sustainable energy production;
Agriculture: edge computing can be used to process and analyze data from sensors in the field, allowing farmers to optimize crop yields and reduce waste;
Fraud Detection: edge computing can be used to detect fraud in real-time by analyzing transaction data at the edge, rather than sending it to a central data center for processing, which can enable faster detection of fraudulent activity and reduce the risk of financial losses;
Customer Service: edge computing can be used to improve customer service by providing real-time analysis of customer data at the edge, enabling faster response times and more personalized service;
Investment Analysis: edge computing can be used to analyze financial market data in real-time, enabling more accurate investment analysis and faster decision-making;
Risk Management: edge computing can be used to monitor and analyze data from sensors and other sources in real-time, allowing financial institutions to identify and mitigate risks more quickly;
ATM and Branch Optimization: edge computing can be used to optimize the performance of ATMs and branches by analyzing real-time data on customer traffic, wait times, and other factors, enabling more efficient use of resources.

There can be various considerations when implementing edge computing in the system 300. Such considerations can include one or more of the following:
Understand the unique characteristics of edge computing: edge computing applications operate in a distributed environment with limited resources and unpredictable network connectivity and, as a result, it can be desirable to design applications that are resilient, scalable, and can operate autonomously;
Adopt a microservices architecture: microservices provide a way to break down complex applications into smaller, more manageable components that can be independently deployed and scaled, and this approach can allow edge computing applications to be more flexible and responsive to changing requirements;
Use containers: containers provide a lightweight and portable way to package and deploy microservices, which can be easily moved between different edge computing nodes, making it easier to scale and manage applications; and
Use edge-native programming languages: edge computing applications often require different programming languages and frameworks than traditional cloud applications, where it can be important to choose languages and frameworks that are optimized for edge computing environments and can take advantage of the unique characteristics of these systems.

There can be various security considerations when implementing edge computing in the system 300. Such security considerations can include one or more of the following:
Secure communication: edge devices and gateways should use secure communication protocols such as Transport Layer Security (TLS) or Secure Sockets Layer (SSL) to protect data as it is transmitted between devices and back-end systems;
Authentication and authorization: strong authentication and authorization mechanisms should be put in place to ensure that only authorized users and devices can access data and systems at the edge;
Data privacy and confidentiality: edge devices often collect sensitive data, such as personal health information or financial data, which should be protected with strong encryption and access control mechanisms to ensure that it is not accessed or manipulated by unauthorized users;
Secure software and firmware updates: edge devices and gateways must be kept up-to-date with the latest security patches and updates to prevent vulnerabilities from being exploited by attackers;
Physical security: edge devices may be deployed in physically vulnerable locations, such as outdoor environments or in remote locations, which means physical security measures, such as tamper-resistant casings and secure mounting hardware, should be put in place to prevent unauthorized access and tampering; and
Monitoring and logging: comprehensive monitoring and logging should be implemented to detect and respond to security incidents in a timely manner, which includes monitoring for anomalous behavior, such as unauthorized access attempts or data exfiltration, and logging all activity for later analysis and investigation.

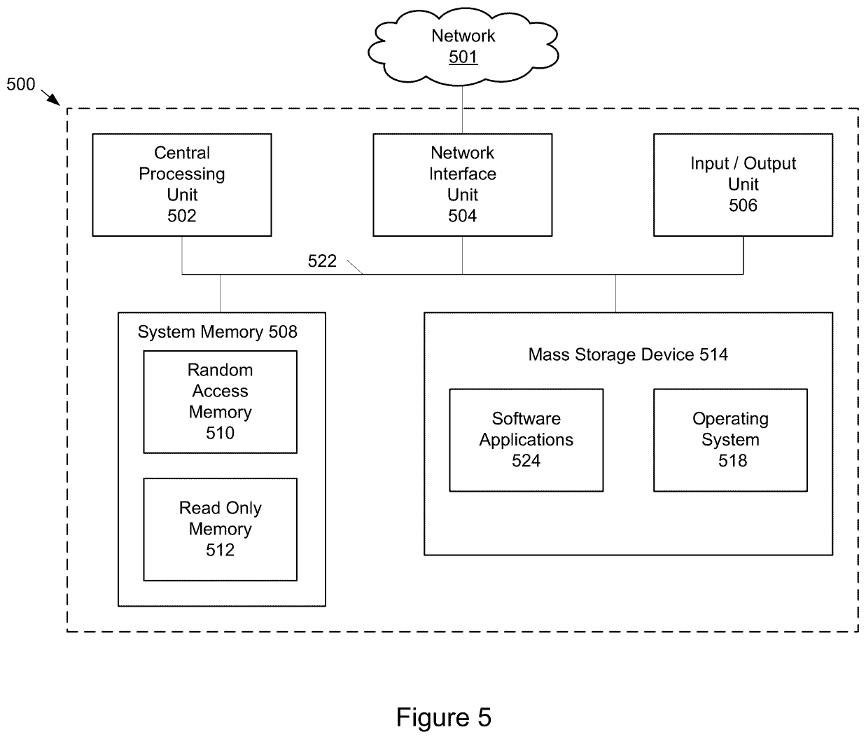

FIG. 5 shows an example computing device 500 that provides at least a portion of the functionality described herein. The computing device 500 can take various forms, such as a mobile computer, a desktop computer, a server computer, or other computing device or devices such as a server farm or cloud computing used to generate or receive data. The example systems 100 and 300 described herein can accommodate hundreds or thousands of the computing devices 500.

In this example, the computing device 500 can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the computing device 500, such as during startup, is stored in the ROM 512. The computing device 500 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the computing device 500. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 500.

According to various embodiments of the invention, the computing device 500 may operate in a networked environment using logical connections to remote network devices through a network 501, such as a wireless network, the Internet, or another type of network. The computing device 500 may connect to network 501 through a network interface unit 504 connected to the system bus 522. It should be appreciated that the network interface unit 504 may also be utilized to connect to other types of networks and remote computing systems. The computing device 500 also includes an input/output controller 506 for receiving and processing input from a number of other devices, including a touch user interface display screen or another type of input device. Similarly, the input/output controller 506 may provide output to a touch user interface display screen or other output devices.

As mentioned briefly above, the mass storage device 514 and the RAM 510 of the computing device 500 can store software instructions and data. The software instructions include an operating system 518 suitable for controlling the operation of the computing device 500. The mass storage device 514 and/or the RAM 510 also store software instructions and applications 524, that when executed by the CPU 502, cause the computing device 500 to provide the functionality of the computing device 500 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for using edge computing to enhance artificial intelligence and advanced analytics, comprising:
one or more processors; and
non-transitory computer-readable storage media encoding instructions which, when executed by the one or more processors, causes the computer system to:
provide a data layer including a data source;
use an edge computing layer to pre-process data from the data source;
perform the artificial intelligence and advanced analytics on the data to form insights into the data;
provide the insights to a data center or a cloud computing environment located remotely from the data source; and
perform further artificial intelligence and advanced analytics on the insights at the data center or the cloud computing environment.

2. The computer system of claim 1, wherein the data layer includes a plurality of different data sources.

3. The computer system of claim 1, wherein the edge computing layer includes a plurality of different edge computers to pre-process the data.

4. The computer system of claim 1, comprising further instructions which, when executed by the one or more processors, causes the computer system to provide edge services in the cloud computing environment.

5. The computer system of claim 4, wherein the edge services are positioned between the data source in the cloud computing environment and the data center.

6. The computer system of claim 1, wherein the cloud computing environment is positioned at a location remote from the data center.

7. The computer system of claim 1, wherein the data source is unstructured, semi-structured, or structured data including customer data.

8. The computer system of claim 7, comprising further instructions which, when executed by the one or more processors, causes the computer system to use the edge computing layer to predict customer behavior as part of the insights.

9. The computer system of claim 1, wherein the artificial intelligence and advanced analytics are programmed to predict, classify, and detect anomalies associated with the data.

10. The computer system of claim 1, wherein the artificial intelligence and advanced analytics are programmed to provide predictive modeling.

11. A method for using edge computing to enhance artificial intelligence and advanced analytics, the method comprising:
providing a data layer including a data source;
using an edge computing layer to pre-process data from the data source;
performing the artificial intelligence and advanced analytics on the data to form insights into the data;
providing the insights to a data center or a cloud computing environment located remotely from the data source; and
performing further artificial intelligence and advanced analytics on the insights at the data center or the cloud computing environment.

12. The method of claim 11, wherein the data layer includes a plurality of different data sources.

13. The method of claim 11, wherein the edge computing layer includes a plurality of different edge computers to pre-process the data.

14. The method of claim 11, further comprising providing edge services in the cloud computing environment.

15. The method of claim 14, wherein the edge services are positioned between the data source in the cloud computing environment and the data center.

16. The method of claim 11, wherein the cloud computing environment is positioned at a location remote from the data center.

17. The method of claim 11, wherein the data source is unstructured, semi-structured, or structured data including customer data.

18. The method of claim 17, further comprising using the edge computing layer to predict customer behavior as part of the insights.

19. The method of claim 11, wherein the artificial intelligence and advanced analytics are programmed to predict, classify, and detect anomalies associated with the data.

20. The method of claim 11, wherein the artificial intelligence and advanced analytics are programmed to provide predictive modeling.
